(19) United States
(12) Patent Application Publication
(10) Pub. No.: US 2007/0075897 A1
(43) Pub. Date: Apr. 5, 2007

(54) Positioning apparatus and positioning method

(75) Inventor: Nobuo Muto, Mastumoto-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/431,105

(22) Filed: May 10, 2006

(30) Foreign Application Priority Data
May 11, 2005 (JP) 2005-138093

(51) Int. Cl. G01S 5/14

(52) U.S. Cl. 342/357.12

(57) ABSTRACT

A positioning apparatus for receiving a positioning standard code which is used as a standard of positioning from a positioning satellite, comprising: analysis assistance code generating means for generating an analysis assistance code for determining which positioning satellite corresponds to the positioning standard code based on the received positioning standard code; positioning standard code identifying means for analyzing the positioning standard code and the analysis assistance code, and identifying which positioning satellite corresponds to the positioning standard code; and current position information generating means for generating current position information indicating a current position based on an identified result by the positioning standard code identifying means.

This application claims the priorities benefit under 35 U.S.C.§119 of Japanese Patent Application No. 2005-138093 filed on May 11, 2005, which is hereby incorporated in its entirety by reference.

### BACKGROUND

1. Technical Field

The present invention relates to a positioning apparatus and a positioning method which use radio waves from positioning satellites.

2. Related Art

Conventionally, positioning systems for positioning a current position of each GPS (Global Positioning System) receiver using a satellite navigation system such as GPS have been used.

Such GPS receiver receives a C/A (Clear and Acquisition or Coarse and Access) code, which is one of the pseudo random noise codes (hereinafter, referred to as PN (Pseudo random Noise code)) putted on radio waves from GPS satellites (hereinafter, referred to as satellite radio waves), based on satellite information indicating a GPS satellite orbit (rough satellite orbit information: almanac, accurate orbit information: ephemeris). The C/A code is a code serving as a positioning standard.

The GPS receiver then identifies which GPS satellite transmits the C/A code, and calculates the distance (pseudo distance) between the GPS satellite and the GPS receiver based on the time at which the C/A code is transmitted and the time at which it is received. The GPS receiver then positions the position of the GPS receiver based on the pseudo distance of three or more of GPS satellites and the position of each GPS satellite on the satellite orbit (e.g., JP-A-10-339772).

Here, since the above-mentioned satellite radio waves are subjected to PSK modulation by PN code such as the C/A code, spectral width expands. This causes degradation of signal to noise ratio (hereinafter, referred to as SNR (Signal to Noise Ratio)) of satellite radio waves, making it difficult to extract the C/A code.

Accordingly, the GPS receiver receives C/A codes from the identical GPS satellite multiple times, and then integrates the sampling results of the C/A codes, thereby improving the SNR. Hereinafter, integration of the sampling results is simply referred to as integration. In addition, integration of codes and integration of the sampling results of codes are identical actions.

However, since a C/A code is repeatedly transmitted for every 1 msec (ms), it takes 20 msec (ms) to receive it 20 times. This develops a problem that it requires a certain time determined by the transmission interval period of the C/A code to integrate the number of times required for extracting the C/A code.

### SUMMARY

Accordingly, an advantage of some aspects of the invention is to provide a positioning apparatus and a positioning method for integrating the number of times required f or extracting a positioning standard code without restrictions imposed by transmission interval period of positioning standard codes.

In order to achieve the above object, a positioning apparatus for receiving positioning standard codes which is used as a standard of positioning from positioning satellites according to a first aspect of the invention includes: analysis assistance code generating means for generating analysis assistance codes for identifying which positioning apparatus corresponds to the positioning standard code based on the received positioning standard codes, positioning standard code identifying means for analyzing the positioning standard codes and the analysis assistance codes and identifying which positioning satellite corresponds to the positioning standard code, and current position information generating means for generating current position information indicating a current position based on the identified result by the positioning standard code identifying means.

With the structure according to the first aspect of the invention, the positioning apparatus can generate analysis assistance codes for analyzing the positioning standard codes using the analysis assistance code generating means.

The positioning apparatus can also analyze the positioning standard codes and the analysis assistance codes, and identify which positioning satellite corresponds to the positioning standard code using the positioning standard code identifying means.

Accordingly, when receiving the positioning standard codes once, the positioning apparatus can generate the number of analysis assistance codes required for identifying which positioning satellite corresponds to the positioning standard code based on the positioning standard code. This means that it is unnecessary for the positioning apparatus to receive the number of positioning standard codes required for identifying which positioning satellite corresponds to the positioning standard code. Accordingly, the positioning apparatus can integrate the sampling results of the positioning standard codes required for extracting the positioning standard codes without restrictions imposed by transmission interval period of the positioning standard codes.

This allows the positioning apparatus to integrate the number of times required for extracting the positioning standard codes without restrictions imposed by transmission interval period of the positioning standard codes.

A second aspect of the invention is a positioning apparatus with a structure according to the first aspect of the invention, wherein the analysis assistance code generating means generates the analysis assistance codes so that the total number of the positioning standard codes and the analysis assistance codes equals the number required for identifying which positioning satellite corresponds to the positioning standard code.

With the structure according to the second aspect of the invention, the analysis assistance code generating means can generate the sufficient number of analysis assistance codes required for identifying which positioning satellite corresponds to the positioning standard code.

A third aspect of the invention is a positioning apparatus with the structure according to any of the first and the second aspect of the invention, wherein the analysis assistance code generating means generates the analysis assistance codes within a range of delay in which the positioning standard code identifying means can identify standard unit code which is a standard unit configuring the positioning standard codes.

In order to identify which positioning satellite corresponds to the positioning standard code, it is necessary to integrate the standard unit codes with each other allocated at the identical position in the positioning standard codes.

With the structure according to the third aspect of the invention, the analysis assistance code generating means can generate the analysis assistance codes within a range of delay in which the analysis means can identify standard unit code which is a standard unit configuring the positioning standard codes. Thus, the positioning standard code identifying means can identify which positioning satellite corresponds to the positioning standard code reliably.

A fourth aspect of the invention is a positioning apparatus with the structure according to any of the first through the third aspect of the invention, wherein the analysis assistance code generating means generates the analysis assistance codes with respect to a part of the positioning standard code.

It is possible to determine which positioning satellite corresponds to the positioning standard code by analyzing a part of the positioning standard code, not all of it.

With the structure according to the fourth aspect of the invention, the analysis assistance code generating means can generate the analysis assistance codes with respect to a part of the positioning standard code. This allows the positioning standard code identifying means to reduce the time required for analysis and identify which positioning satellite corresponds to the positioning standard code.

In order to achieve the above object, a positioning method according to a fifth aspect of the invention includes: an analysis assistance code generating step in which a positioning apparatus for receiving positioning standard code which is a positioning standard from a positioning apparatus generates analysis assistance code for determining which positioning satellite corresponds to the positioning standard code based on the received positioning standard code, a positioning standard code identifying step in which the positioning apparatus analyzes the positioning standard code and the analysis assistance code, and identifies which positioning satellite corresponds to the positioning standard code, and a current position information generating step in which the positioning apparatus generates current position information indicating a current position based on an identified result by the positioning standard code identifying step.

With the structure according to the fifth aspect of the invention, as with the first aspect of the invention, it is possible to integrate the number of times required for extracting positioning standard codes without restrictions imposed by transmission interval period of positioning standard codes.

### BRIEF DESCRIPTION OF THE DRAWINGS

The invention will be described with reference to the accompanying drawings, wherein like numbers reference like elements.

FIG. 1 schematically shows a positioning system in an embodiment according to the invention.

FIG. 2 schematically shows codes C1 and the like.

FIG. 3 schematically shows codes C1 and the like.

FIG. 4 schematically shows a main structure of a GPS apparatus.

FIG. 5 schematically shows a main hardware structure of a terminal.

FIG. 6 schematically shows a main software structure of the terminal.

FIG. 7 schematically shows a flowchart of an operation example of the positioning system.

FIG. 8 schematically shows a main structure of the GPS apparatus.

FIG. 9 schematically shows codes C1 and the like.

### DESCRIPTION OF EXEMPLARY EMBODIMENTS

Hereinafter, with reference to the drawings, the preferred exemplary embodiments of the invention will be described in detail.

The following embodiments are given various limitations that are preferable technically because they are the exemplary specific examples of the invention, however, the scope of the invention is not limited to these aspects unless there is a particular description to limit the invention in the following description.

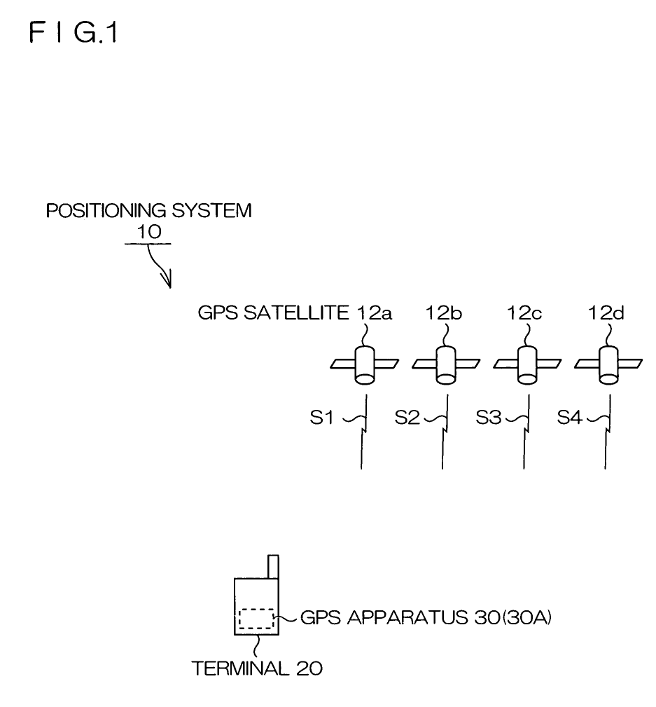

FIG. 1 schematically illustrates a positioning system 10 according to an embodiment of the invention.

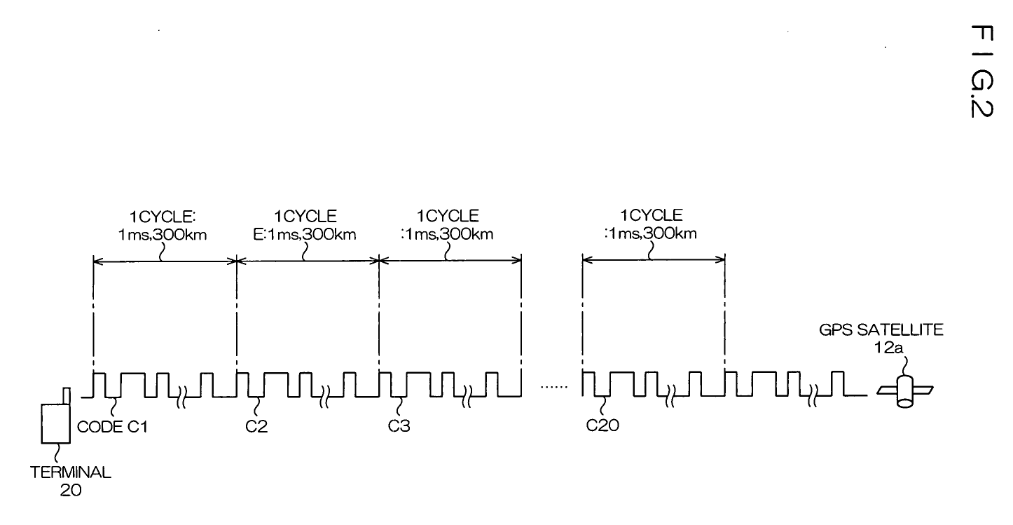

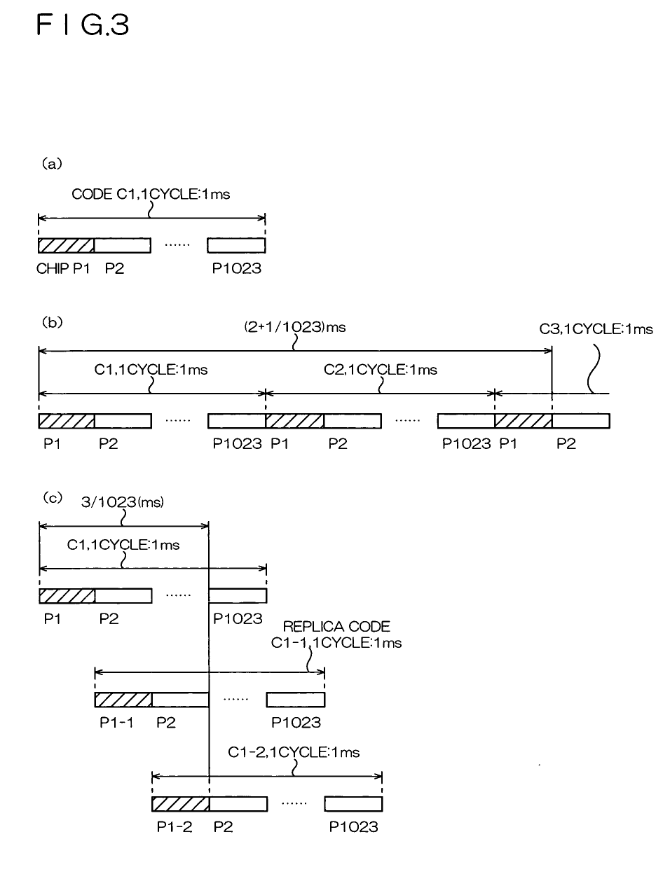

FIGS. 2 and 3 schematically illustrate codes C1 and the like transmitted from GPS satellites 12a and the like.

As illustrated in FIG. 1, the positioning system 10 includes positioning satellites, such as the GPS satellites 12a, 12b, 12c and 12d. The GPS 12a and the like transmit radio waves S1, S2, S3 and S4, respectively, on which various codes are putted. One of these codes is C/A code. The codes C1 through C20 in FIG. 2 are C/A codes. The codes C1 through C20 are, for example, the identical code continuously transmitted from the GPS satellite 12a. For example, the code C1 is the C/A code transmitted prior to the code C2. The codes C1 and the like are an example of positioning standard code. The codes C1 and the like are also an example of a PRN (Pseudo Random Noise) code.

The positioning system 10 includes a terminal 20. The terminal 20 includes a GPS apparatus 30, and thus can receive the codes C1 and the like putted on the radio waves S1 and the like from the GPS satellites 12a and the like.

The terminal 20 then receives C/A codes from three or more of different GPS satellites 12a and the like, allowing positioning of a current position. The codes C1 and the like have a cycle of 1 msec (ms), which corresponds to the distance of 300 kilometers (km). The codes C1 and the like differ for each of the GPS satellites 12a and the like.

First, the terminal 20 identifies which GPS satellite corresponds to the code C1 or the like. Hereinafter, identification which GPS satellite corresponds to the code C1 or the like is referred to as extraction of the code C1 or the like or the C/A code. Next, the distance between each of the GPS satellites 12a and the like and the terminal 20 (hereinafter, referred to as pseudo distance) is calculated using light-speed propagation of the radio wave S1 on which codes are putted based on the difference between the time at which the codes C1 and the like are transmitted from each of the GPS satellites 12a and the like and the time at which the code C1 is received. A current position is then positioned based on the position of each of the GPS satellites 12a and the like on the satellite orbit at the current time and the above-mentioned pseudo distance.

It should be noted that four GPS satellites 12a and the like are illustrated in FIG. 1, however, the number of the GPS satellites 12a and the like may be three or five or more.

As illustrated in FIG. 3(a), the code C1 is configured with 1,023 chips P1 through P1023. The chips P1 and the like are a standard unit, which configures the code C1 and indicates a numerical value of 0 or 1. The chips P1 and the like are an example of standard unit code.

In order to extract the C/A code, it is necessary to identify each chip P1 or the like is either 0 or 1. Hereinafter, identification of each chip P1 or the like being either 0 or 1 is referred to as identification of chip P1 and the like. The identification of chip P1 and the like is an example of analysis.

However, since the above-mentioned radio waves S1 and the like are subjected to PSK modulation by PN code such as C/A code, spectral width expands. This causes degradation of SNR, making it difficult to identify each chip P1 or the like.

Assuming that the GPS receiver receives the C/A code three times from the GPS satellite 12a, and integrates the sampling results of the C/A codes to improve the SNR, for example, as illustrated in FIG. 3(b), it takes (2+ 1/1023) msec (ms) to identify the chip P1. This is because the code 1 should be received first, the code 2 should then be received, and the chip P1 section of the code C3 should then be received in order to receive the chip P1 three times. In other words, it takes a certain time determined by a cycle of the C/A code to receive the chip P1.

With the following structure, the terminal 20 in the embodiment according to the invention can identify the chips P1 and the like without restrictions imposed by a certain time determined by the cycle of the C/A code.

Structure of GPS Apparatus 30

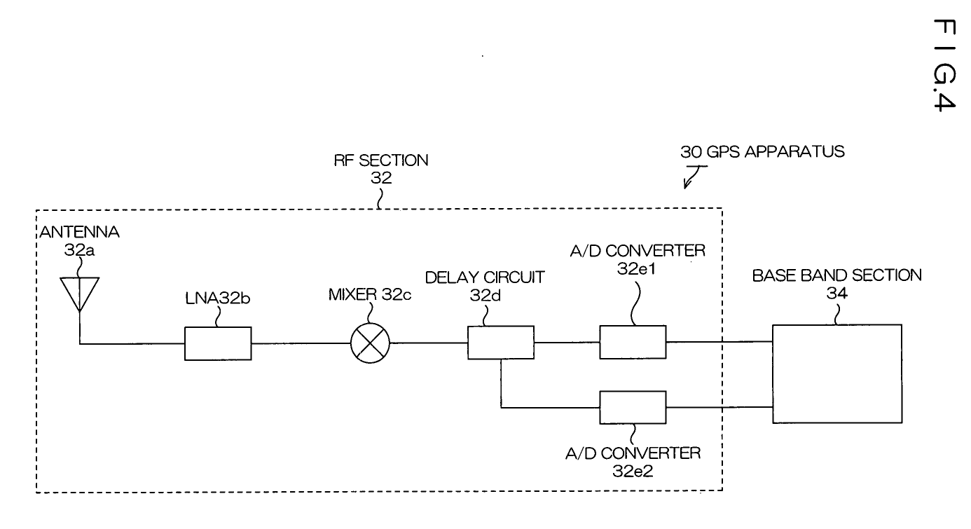

FIG. 4 schematically illustrates a structure of the GPS apparatus 30.

As illustrated in FIG. 4, the GPS apparatus 30 includes an RF section 32 and a base band section 34.

The RF section 32 receives C/A codes using an antenna 32a. An amplifier LNA 32b amplifies the C/A codes. A mixer 32c then converts the frequency of the C/A codes. A delay circuit 32d including an IQ detector carries out IQ separation of the C/A codes. A/D converters 32e1 and 32e2 then converts the C/A codes subjected to IQ separation into digital signals, respectively.

The base band section 34 receives the C/A codes converted into digital signals from the RF section 32, samples and integrates each chip P1 or the like (see FIG. 3(a)), and correlates with the C/A codes stored in the base band section 34, thereby identifying the received C/A codes.

Main Hardware Structure of Terminal 20

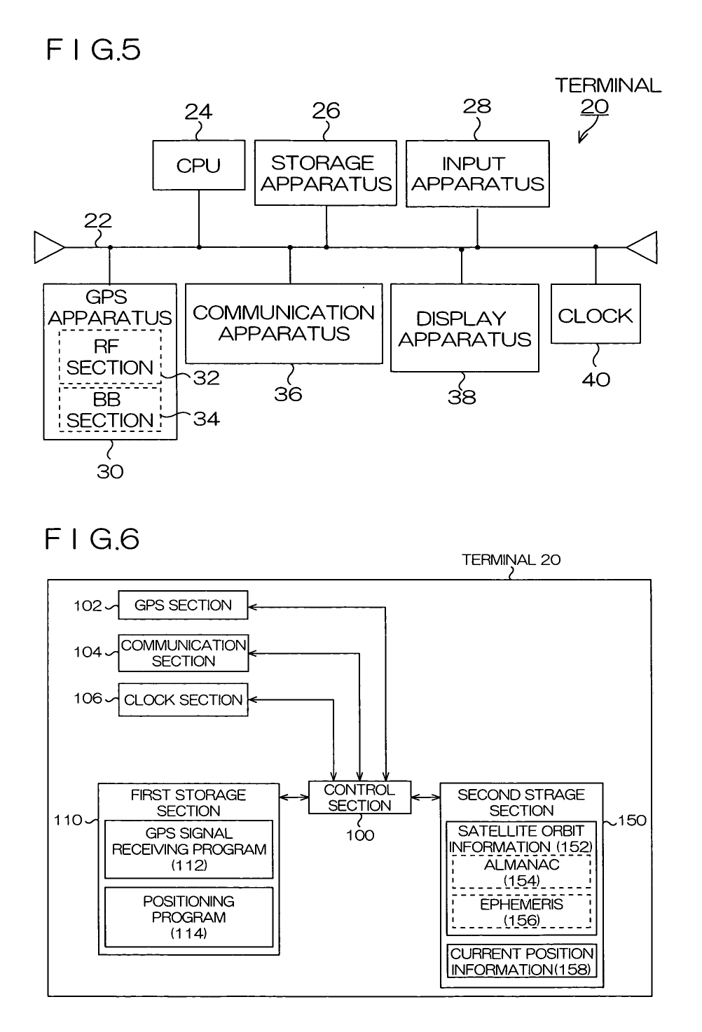

FIG. 5 schematically illustrates a main hardware structure of the terminal 20.

As illustrated in FIG. 5, the terminal 20 includes a computer, which is equipped with a bus 22. A CPU (Central Processing Unit) 24, a storage apparatus 26, and the like are connected with the bus 22. The storage apparatus may be a RAM (Random Access Memory), a ROM (Read Only Memory), or the like.

An input apparatus 28, the GPS apparatus 30, a communication apparatus 36, a display apparatus 38, and a clock 40 are also connected with the bus 22.

Main Software Structure of Terminal 20

FIG. 6 schematically illustrates a main software structure of the terminal 20.

As illustrated in FIG. 6, the terminal 20 includes a control section 100 for controlling each section, a GPS section 102 corresponding to the GPS apparatus 30 in FIG. 5, a communication section 104 corresponding to the communication apparatus 36, a clock section corresponding to the clock 40, and the like.

The terminal 20 also includes a first storage section 110 for storing each program and a second storage section 150 for storing each pieces of information.

As illustrated in FIG. 6, the terminal 20 stores satellite orbit information 152 in the second storage section 150. The satellite orbit information 152 includes almanac 154 and ephemeris 156. The almanac 154 is information indicating a rough orbit of all GPS satellites 12a and the like. The ephemeris 156 is information indicating an accurate orbit of each of the GPS satellites 12a and the like. The terminal 20 uses the almanac 154 and the ephemeris 156 for positioning.

As illustrated in FIG. 6, the terminal 20 stores GPS signal receiving program 112 in the first storage section 110. The GPS signal receiving program 112 is a program that the control section 100 receives the C/A codes putted on the radio wave S1 from the GPS satellite 12a or the like using the GPS section 102.

The GPS apparatus 30 (see FIG. 4) instructed by the control section 100 first receives the C/A codes using the antenna 32a. For example, it is assumed that the code C1 is received from the GPS satellite 12a (see FIG. 3(c)).

The code C1 is received by the delay circuit 32d passing through the LNA 32b and the mixer 32c.

The delay circuit 32d generates replica codes C1-1 and C1-2, which are replicas of the code C1, based on the code C1 (see FIG. 3(c)). The replica codes C1-1 and C1-2 are codes for identifying which GPS satellite corresponds to the code C1 by the base band section 34. In other words, the replica codes C1-1 and C1-2 are an example of analysis assistance codes. The delay circuit 32d is an example of analysis assistance code generating means.

As illustrated in FIG. 3(c), the delay circuit 32d generates the replica code C1-1 having a 1-chip delay with respect to the code C1, and also generates the replica code C1-2 having a 1-chip delay with respect to the replica code C1-1.

The delay circuit 32d generates the replica codes C1-1 and the like so that the total number of the code C1 and the replica codes C1-1 and the like equals the number required for identifying which GPS satellite corresponds to the code C1 (hereinafter, referred to as the number required for code identification). The number required for code identification may be 20, for example, however, it is three herein for simplifying the description.

The number required for code identification is not limited as in this embodiment, but may be changeable for each positioning based on the positioning conditions including receiving intensity of the radio waves S1 and the like, and PDOP (Position Dilution Of Precision) and the like.

The delay circuit 32d generates the code C1 and the replica codes C1-1 and the like within a range of delay in which the base band section 34 can identify the chip P1 and the like. For example, when the base band section 34 recognizes that the chips P1 and the like having a 1-chip delay, respectively, are the chips at the identical position in the code C1 and the replica codes C1-1 and the like, the replica codes C1-1 and the like having a 1-chip delay, respectively, with respect to the code C1 are generated as illustrated in FIG. 3(c).

The invention is not limited to this embodiment, for example, when the base band section 34 recognizes that the chips P1 and the like having a 2-chip delay, respectively, are the chips at the identical position in the code C1 and the replica codes C1-1 and the like, the replica codes C1-1 and the like having a 2-chip delay, respectively, with respect to the code C1 may be generated.

The delay circuit 32d also generates the replica codes C1-1 and the like with respect to a part of the code C1. It is not necessary to sample all chips P1 and the like in the code C1 but, for example, only 500 chips when the base band section 34 identifies which GPS satellite corresponds to the code C1. Accordingly, the delay circuit 32d replicates the code C1 in a range required for the base band section 34 to identify which GPS satellite corresponds to the code C1.

In FIG. 3(c), all 1,023 chips are duplicated for convenience of the description.

The code C1 and the replica codes C1-1 and the like are subjected to IQ separation by the detector in the delay circuit 32d, and the results are transmitted to the A/D converters 32e1 and 32e2, respectively. As soon as being generated, the code C1 and the replica codes C1-1 and the like converted into digital signals are then transmitted to the base band section 34.

In the base band section 34, the code C1 and the replica codes C1-1 and the like are sampled in units of the chip P1 or the like, and the sampling results are integrated. The integrated sampling results and the C/A codes stored in the base band section 34 are then correlated, thereby identifying which GPS satellite corresponds to the received code C1. In other words, the base band section 34 is an example of the positioning standard code identifying means.

Here, the replica codes C1-1 and the like are generated so as to have a 1-chip delay with respect to the code C1, respectively. Paying attention to the first chip P1 in the codes C1 and the like, it has a delay of 1/1023 msec (ms), respectively. Accordingly, the base band section 34 takes 3/1023 msec (ms) to receive the replica codes C1-1 and C1-2 after receiving the code C1.

If we receive the C/A code three times, and receive the respective chips P1 three times, for example, it takes (2+ 1/1023) msec (ms) as described above.

On the other hand, according to this embodiment, the base band section 34 takes extremely shorter time, only 3/1023 msec (ms) to receive the replica codes C1-1 and C1-2 after receiving the code C1.

The base band section 34 identifies which GPS satellite corresponds to the code 1, as well as the phase of the code C1.

As illustrated in FIG. 6, the terminal 20 stores positioning program 114 in the first storage section 110. The positioning program 114 is a program that the control section 100 generates current position information 158 indicating a current position based on the identified results by the GPS section 102. In other words, the positioning program 114 and the control section 100 are an example of the current position information generating means.

The terminal 20 is configured as described above.

As mentioned above, the terminal 20 can generate the replica codes C1-1 and the like.

The terminal 20 samples the code C1 and the replica codes C1-1 and the like, and can identify which GPS satellite corresponds to the code C1.

Accordingly, when receiving the code C1 once, the terminal 20 can generate the number of replica codes C1-1 and the like required for identifying which GPS satellite corresponds to the code C1 based on the code C1. This means that it is unnecessary for the terminal 20 to receive the number of codes C1 and the like required for identifying which GPS satellite corresponds to the code C1. Thus, the terminal 20 may integrate the sampling results of the code C1 and the replica codes C1-1 and the like required for extracting the code C1 without restrictions imposed by transmission interval period of the codes C1 and the like.

This allows the terminal 20 to integrate the number of times required for extracting the codes C1 and the like without restrictions imposed by transmission interval period of the codes C1 and the like.

The terminal 20 also generates the replica codes C1-1 and the like so that the total number of the code C1 and the replica codes C1-1 and the like equals the number required for identifying which GPS satellite corresponds to the code C1.

This allows the terminal 20 to generate the sufficient number of replica codes C1-1 and the like required for identifying which GPS satellite corresponds to the code C1.

The terminal 20 also generates the replica codes C1-1 and the like within a range of delay in which the base band section 34 can identify the chips P1 and the like which are standard units configuring the code C1. In order to identify which GPS satellite corresponds to the code C1 or the like, the chips P1 and the like allocated at the identical position in the code C1 and the replica codes C1-1 and the like must be integrated with each other.

The terminal 20 generates the replica codes C1-1 and the like within a range of delay in which the base band section 34 can identify which GPS satellite corresponds to the code C1 or the like. Accordingly, the base band section 34 can identify which GPS satellite corresponds to the code C1 reliably.

The terminal 20 also generates the replica codes C1-1 and the like with respect to a part of the code C1 or the like.

As described above, it is possible to identify which GPS satellite corresponds to the code C1 by sampling only a part of the code C1, not all of the code C1.

The terminal 20 generates the replica codes C1-1 and the like with respect to a part of the code C1 or the like. This allows the terminal 20 to reduce the sampling time and identify which GPS satellite corresponds to the code C1 or the like.

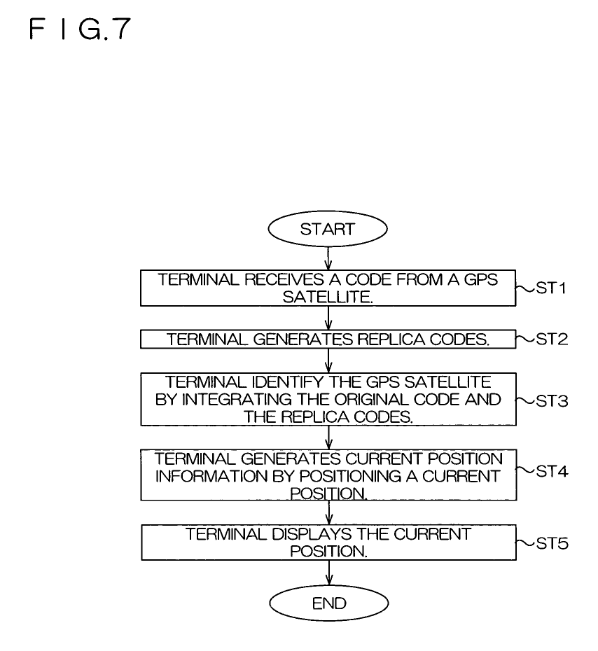

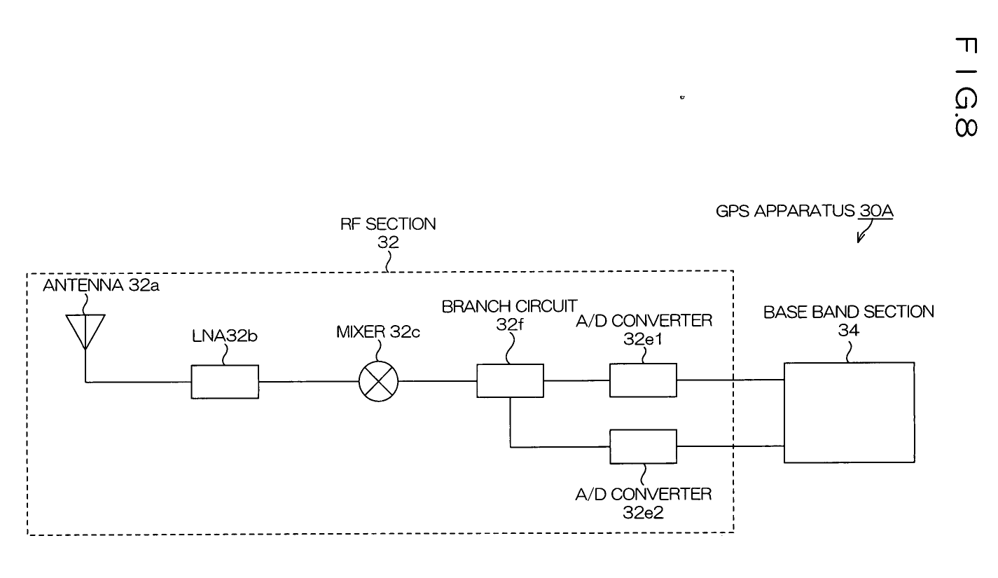

The structure of the terminal 20 in the embodiment according to the invention is described above. The operation example is hereinafter described mainly using FIG. 7.

FIG. 7 schematically illustrates a flowchart of an operation example of the terminal 20.

First, the terminal 20 receives a C/A code C1 putted on the radio wave S1 from the GPS satellite 12a, for example (step ST1 in FIG. 7).

Subsequently, the terminal 20 generates the replica codes C1-1 and the like (see FIG. 3(c)) (step ST2). The step ST2 is an example of the analysis assistance code generating step.

Afterwards, the terminal 20 integrates the original code C1 and the replica codes C1-1 and the like, and identifies which GPS satellite corresponds to the code C1 (step ST3). The step ST3 is an example of the positioning standard code identifying step.

The terminal 20 then positions a current position, and generates the current position information 158 (see FIG. 6) (step ST4). The step ST4 is an example of the current position information generating step.

Next, the terminal 20 displays the current position information 158 on the display apparatus 38 (see FIG. 5) (step ST5).

As mentioned above, the terminal 20 can integrate the number of times required for extracting the codes C1 and the like without restrictions imposed by transmission interval period of the codes C1 and the like.

### Modified Example of the Embodiment

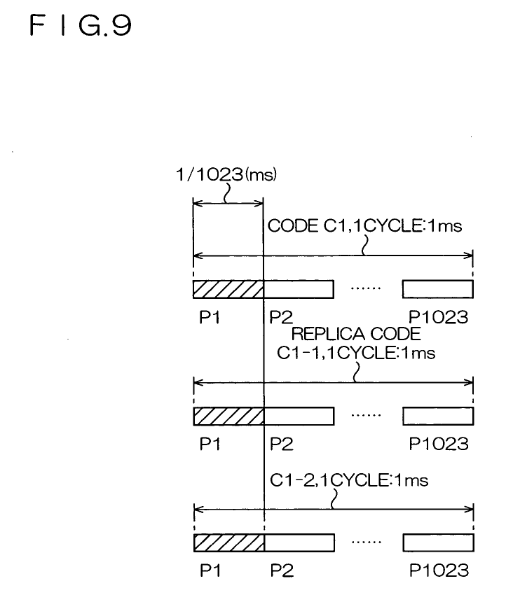

Next, the modified example of the embodiment is described mainly using FIGS. 8 and 9.

FIG. 8 schematically illustrates a structure of a GPS apparatus 30A in the modified example of the embodiment.

FIG. 9 schematically illustrates codes C1 and the like.

As illustrated in FIG. 8, the GPS apparatus 30A includes a branch circuit 32f.

As illustrated in FIG. 9, the branch circuit 32f generates replica codes C1-1 and C1-2 without delay with respect to the code C1.

This allows a base band section 34 to receive the code C1 and the replica codes C1-1 and C1-2 simultaneously. Accordingly, the base band section 34 takes only 1/1023 msec (ms) to receive the respective chips P1 in the code C1 and the replica codes C1-1 and C1-2. The base band section 34 can execute sampling for the respective chips P1 in the code C1 and the replica codes C1-1 and C1-2 at once.

If we receive the C/A code three times, and receive the respective chips P1 three times, for example, it takes (2+ 1/1023) msec (ms) to, as described above.

On the other hand, according to this embodiment, the base band section 34 takes extremely shorter time, only 1/1023 msec (ms) to receive and sample the replica codes C1-1 and C1-2 after receiving the code C1.

The present invention is not limited to the above-described respective embodiments. Further, the above-described respective embodiments may be combined with each other.

What is claimed is:

1. A positioning apparatus for receiving a positioning standard code which is used as a standard of positioning from a positioning satellite, comprising:
analysis assistance code generating means for generating an analysis assistance code for determining which positioning satellite corresponds to the positioning standard code based on the received positioning standard code;
positioning standard code identifying means for analyzing the positioning standard code and the analysis assistance code, and identifying which positioning satellite corresponds to the positioning standard code; and
current position information generating means for generating current position information indicating a current position based on an identified result by the positioning standard code identifying means.

2. The positioning apparatus of claim 1, wherein the analysis assistance code generating means generates the analysis assistance code so that the total number of the positioning standard code and the analysis assistance code equals the number required for identifying which positioning satellite corresponds to the positioning standard code.

3. The positioning apparatus of any of claims 1 and 2, wherein the analysis assistance code generating means generates the analysis assistance code within a range of delay in which the positioning standard code identifying means can identify standard unit code, which is a standard unit configuring the positioning standard code.

4. The positioning apparatus of any of claims 1 through 3, wherein the analysis assistance code generating means generates the analysis assistance code with respect to a part of the positioning standard code.

5. A positioning method, comprising:
an analysis assistance code generating step in which a positioning apparatus for receiving a positioning standard code which is used as a standard of positioning from a positioning apparatus generates an analysis assistance code for determining which positioning satellite corresponds to the positioning standard code based on the received positioning standard code;
a positioning standard code identifying step in which the positioning apparatus analyzes the positioning standard code and the analysis assistance code, and identifies which positioning satellite corresponds to the positioning standard code; and
a current position information generating step in which the positioning apparatus generates current position information indicating a current position based on an identified result by the positioning standard code identifying step.
